(19) United States
(12) Patent Application Publication
(10) Pub. No.: US 2018/0102793 A1
(43) Pub. Date: Apr. 12, 2018

(54) LOCATION AWARE SOFTWARE DEFINED RADIO OPTIMIZATION ARCHITECTURE

(71) Applicant: GM GLOBAL TECHNOLOGY OPERATIONS LLC, Detroit, MI (US)

(72) Inventors: Timothy J. Talty, Beverly Hills, MI (US); Mohiuddin Ahmed, Moorpark, CA (US); Cynthia D. Baringer, Malibu, CA (US); Jongchan Kang, Moorpark, CA (US); Yen-Cheng Kuan, Los Angeles, CA (US); James Chingwei Li, Simi Valley, CA (US); Emilio A. Sovero, Thousand Oaks, CA (US)

(21) Appl. No.: 15/286,825

(22) Filed: Oct. 6, 2016

(51) Int. Cl. H04B 1/00; H04W 4/02

(52) U.S. Cl. CPC H04B 1/0003; H04W 4/02; H04W 84/12; H04B 1/0032; H04B 1/0039; H04B 1/0035

(57) ABSTRACT

A method and apparatus for dynamically modifying filter characteristics of a Delta-Sigma modulator. The system is used for wide bandwidth radio system designed to adapt to various global radio standards and, more particularly, to a cellular radio architecture that employs a combination of a single circulator, programmable band-pass sampling radio frequency (RF) front-end and optimized digital baseband that is capable of supporting all current cellular wireless access protocol frequency bands.

### BACKGROUND OF THE INVENTION

### Field of the Invention

The present application generally relates to wide bandwidth radio system designed to adapt to various global radio standards and, more particularly, to a cellular radio architecture that employs a combination of a single circulator, programmable band-pass sampling radio frequency (RF) front-end and optimized digital baseband that is capable of supporting all current cellular wireless access protocol frequency bands.

### Discussion of the Related Art

Traditional cellular telephones employ different modes and bands of operation that have been supported in hardware by having multiple disparate radio front-end and baseband processing chips integrated into one platform, such as tri-band or quad-band user handsets supporting global system for mobile communications (GSM), general packet radio service (GPRS), etc. Known cellular receivers have integrated some of the antenna and baseband data paths, but nevertheless the current state of the art for mass mobile and vehicular radio deployment remains a multiple static channelizing approach. Such a static architecture is critically dependent on narrow-band filters, duplexers and standard-specific down-conversion to intermediate-frequency (IF) stages. The main disadvantage of this static, channelized approach is its inflexibility with regards to the changing standards and modes of operation. As the cellular communications industry has evolved from 2G, 3G, 4G and beyond, each new waveform and mode has required a redesign of the RF front-end of the receiver as well as expanding the baseband chip set capability, thus necessitating a new handset. For automotive applications, this inflexibility to support emerging uses is prohibitively expensive and a nuisance to the end-user.

Providing reliable automotive wireless access is challenging from an automobile manufacturers point of view because cellular connectivity methods and architectures vary across the globe. Further, the standards and technologies are ever changing and typically have an evolution cycle that is several times faster than the average service life of a vehicle. More particularly, current RF front-end architectures for vehicle radios are designed for specific RF frequency bands. Dedicated hardware tuned at the proper frequency needs to be installed on the radio platform for the particular frequency band that the radio is intended to operate at. Thus, if cellular providers change their particular frequency band, the particular vehicle that the previous band was tuned for, which may have a life of 15 to 20 years, may not operate efficiently at the new band. Hence, this requires automobile manufactures to maintain a myriad of radio platforms, components and suppliers to support each deployed standard, and to provide a path to upgradability as the cellular landscape changes, which is an expensive and complex proposition.

Known software-defined radio architectures have typically focused on seamless baseband operations to support multiple waveforms and have assumed similar down-conversion-to-baseband specifications. Similarly, for the transmitter side, parallel power amplifier chains for different frequency bands have typically been used for supporting different waveform standards. Thus, receiver front-end architectures have typically been straight forward direct sampling or one-stage mixing methods with modest performance specifications. In particular, no prior application has required a greater than 110 dB dynamic range with associated IP3 factor and power handling requirements precisely because such performance needs have not been realizable with complementary metal oxide semiconductor (CMOS) analog technologies. It has not been obvious how to achieve these metrics using existing architectures for CMOS devices, thus the dynamic range, sensitivity and multi-mode interleaving for both the multi-bit analog-to-digital converter (ADC) and the digital-to-analog converter (DAC) is a substantially more difficult problem.

Delta-sigma modulators are becoming more prevalent in digital receivers because, in addition to providing wideband high dynamic range operation, the modulators have many tunable parameters making them a good candidate for reconfigurable systems. It would be desirable to have a novel radio frequency situational awareness tool which can be used with a software defined radio architecture to improve the service provided to a mobile communication user. In particular, it is desirable to improve the bearer selection and optimization protocols to be used in automotive applications of a multi-function transceiver.

### SUMMARY OF THE INVENTION

The present disclosure describes a method comprising determining a location, determining a waveform parameter associated with the location, configuring a software defined radio according to the waveform parameter, and decoding a signal encoded according to the waveform parameter.

The present disclosure further describes an apparatus comprising a location sensor for determining a location, a memory for storing a waveform parameter, and a software defined radio for retrieving the waveform parameter in response to the location, and for configuring the software defined radio in response to the waveform parameter, the software defined radio further operative to decode a signal according to the waveform parameter.

Additional features of the present invention will become apparent from the following description and appended claims, taken in conjunction with the accompanying drawings.

### BRIEF DESCRIPTION OF THE DRAWINGS

FIG. 1 shows a block diagram of a known multi-mode, multi-band cellular communications handset architecture;

FIG. 2 shows a block diagram of a software-programmable cellular radio architecture applicable;

FIG. 3 shows an exemplary system for implementing location aware software defined radio (SDR) optimization architecture.

FIG. 4 shows an exemplary method for implementing location aware software defined radio (SDR) optimization architecture.

FIG. 5 is a transceiver for implementing location aware software defined radio (SDR) optimization architecture.

### DETAILED DESCRIPTION OF THE EMBODIMENTS

The following discussion of the embodiments of the invention directed to a cellular radio architecture is merely exemplary in nature, and is in no way intended to limit the invention or its applications or uses. For example, the radio architecture of the invention is described as having application for a vehicle. However, as will be appreciated by those skilled in the art, the radio architecture may have applications other than automotive applications.

The cellular radio architectures discussed herein are applicable to more than cellular wireless technologies, for example, WiFi (IEEE 802.11) technologies. Further, the cellular radio architectures are presented as a fully duplexed wireless system, i.e., one that both transmits and receives. For wireless services that are receive only, such as global positioning system (GPS), global navigation satellite system (GNSS) and various entertainment radios, such as AM/FM, digital audio broadcasting (DAB), SiriusXM, etc., only the receiver design discussed herein would be required. Also, the described radio architecture design will enable one radio hardware design to function globally, accommodating various global wireless standards through software updates. It will also enable longer useful lifespan of the radio hardware design by enabling the radio to adapt to new wireless standards when they are deployed in the market. For example, 4G radio technology developments and frequency assignments are very dynamic. Thus, radio hardware deployed in the market may become obsolete after just one or two years. For applications, such as in the automotive domain, the lifespan can exceed ten years. This invention enables a fixed hardware platform to be updateable through software updates, thus extending the useful lifespan and global reuse of the hardware.

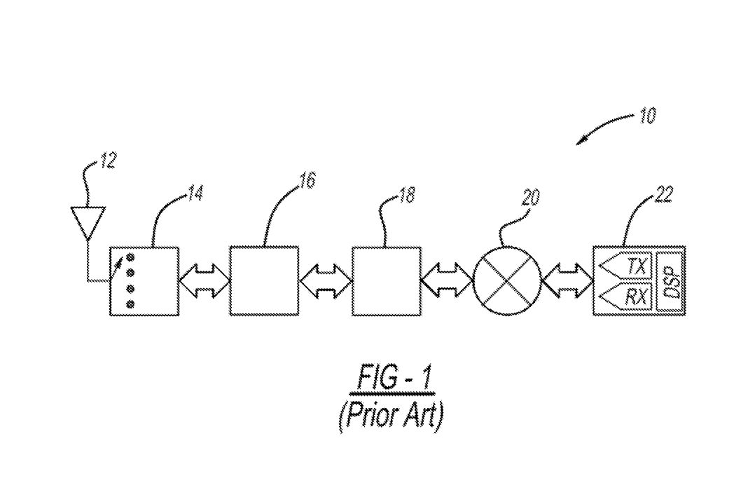

FIG. 1 is a block diagram of a known multi-mode, multi-band cellular communications user handset architecture 10 for a typical cellular telephone. The architecture 10 includes an antenna structure 12 that receives and transmits RF signals at the frequency band of interest. The architecture 10 also includes a switch 14 at the very front-end of the architecture 10 that selects which particular channel the transmitted or received signal is currently for and directs the signal through a dedicated set of filters and duplexers represented by box 16 for the particular channel. Modules 18 provide multi-mode and multi-band analog modulation and demodulation of the receive and transmit signals and separates the signals into in-phase and quadrature-phase signals sent to or received from a transceiver 20. The transceiver 20 also converts analog receive signals to digital signals and digital transmit signals to analog signals. A baseband digital signal processor 22 provides the digital processing for the transmit or receive signals for the particular application.

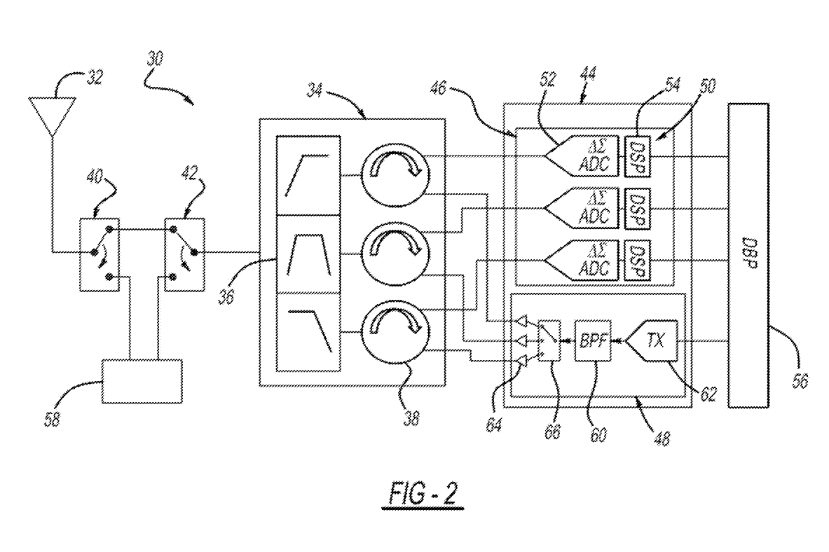

FIG. 2 is a schematic block diagram of a cellular radio front-end architecture 30 that provides software programmable capabilities as will be discussed in detail below. The architecture 30 includes an antenna structure 32 capable of receiving and transmitting the cellular frequency signals discussed herein, such as in a range of 400 MHz-3.6 GHz. Signals received and transmitted by the antenna structure 32 go through a multiplexer 34 that includes three signal paths, where each path is designed for a particular frequency band as determined by a frequency selective filter 36 in each path. In this embodiment, three signal paths have been selected, however, the architecture 30 could be expanded to any number of signal paths. Each signal path includes a circulator 38 that separates and directs the receive and transmit signals, and provides isolation so that the high power signals being transmitted do not enter the receiver side and saturate the receive signals at those frequency bands.

The architecture 30 also includes a front-end transceiver module 44 that is behind the multiplexer 34 and includes a receiver module 46 that processes the receive signals and a transmitter module 48 that processes the transmit signals. The receiver module 46 includes three receiver channels 50, one for each of the signal paths through the multiplexer 34, where a different one of the receiver channels 50 is connected to a different one of the circulators 38, as shown. Each of the receiver channels 50 includes a delta-sigma modulator 52 that receives the analog signal at the particular frequency band and generates a representative stream of digital data using an interleaving process in connection with a number of N-bit quantizer circuits operating at a very high clock rate, as will be discussed in detail below. As will further be discussed, the delta-sigma modulator 52 compares the difference between the receive signal and a feedback signal to generate an error signal that is representative of the digital data being received. The digital data bits are provided to a digital signal processor (DSP) 54 that extracts the digital data stream. A digital baseband processor (DBP) 56 receives and operates on the digital data stream for further signal processing in a manner well understood by those skilled in the art. The transmitter module 48 receives digital data to be transmitted from the processor 56. The module 48 includes a transmitter circuit 62 having a delta-sigma modulator that converts the digital data from the digital baseband processor 56 to an analog signal. The analog signal is filtered by a tunable bandpass filter (BPF) 60 to remove out of band emissions and sent to a switch 66 that directs the signal to a selected power amplifier 64 optimized for the transmitted signal frequency band. In this embodiment, three signal paths have been selected, however, the transmitter module 48 could be implemented using any number of signal paths. The amplified signal is sent to the particular circulator 38 in the multiplexer 34 depending on which frequency is being transmitted.

As will become apparent from the discussion below, the configuration of the architecture 30 provides software programmable capabilities through high performance delta-sigma modulators that provide optimized performance in the signal band of interest and that can be tuned across a broad range of carrier frequencies. The architecture 30 meets current cellular wireless access protocols across the 0.4-2.6 GHz frequency range by dividing the frequency range into three non-continuous bands. However, it is noted that other combinations of signal paths and bandwidth are of course possible. The multiplexer 34 implements frequency domain de-multiplexing by passing the RF carrier received at the antenna structure 32 into one of the three signal paths. Conversely, the transmit signal is multiplexed through the multiplexer 34 onto the antenna structure 32. For vehicular wireless access applications, such a low-cost integrated device is desirable to reduce parts cost, complexity, obsolescence and enable seamless deployment across the globe.

The delta-sigma modulators 52 may be positioned near the antenna structure 32 so as to directly convert the RF receive signals to bits in the receiver module 46 and bits to an RF signal in the transmitter module 48. The main benefit of using the delta-sigma modulators 52 in the receiver channels 50 is to allow a variable signal capture bandwidth and variable center frequency. This is possible because the architecture 30 enables software manipulation of the modulator filter coefficients to vary the signal bandwidth and tune the filter characteristics across the RF band, as will be discussed below.

The architecture 30 allows the ability to vary signal capture bandwidth, which can be exploited to enable the reception of continuous carrier aggregated waveforms without the need for additional hardware. Carrier aggregation is a technique by which the data bandwidths associated with multiple carriers for normally independent channels are combined for a single user to provide much greater data rates than a single carrier. Together with MIMO, this feature is a requirement in modern 4G standards and is enabled by the orthogonal frequency division multiplexing (OFDM) family of waveforms that allow efficient spectral usage.

The architecture 30 through the delta-sigma modulators 52 can handle the situation for precise carrier aggregation scenarios and band combinations through software tuning of the bandpass bandwidth, and thus enables a multi-segment capture capability. Dynamic range decreases for wider bandwidths where more noise is admitted into the sampling bandpass. However, it is assumed that the carrier aggregation typically makes sense when the user has a good signal-to-noise ratio, and not cell boundary edges when connectivity itself may be marginal. Note that the inter-band carrier aggregation is automatically handled by the architecture 30 since the multiplexer 34 feeds independent modulators in the channels 50.

The circulators 38 route the transmit signals from the transmitter module 48 to the antenna structure 32 and also provide isolation between the high power transmit signals and the receiver module 46. Although the circulators 38 provide significant signal isolation, there is some port-to-port leakage within the circulator 38 that provides a signal path between the transmitter module 48 and the receiver module 46. A second undesired signal path occurs due to reflections from the antenna structure 32, and possible other components in the transceiver. As a result, a portion of the transmit signal will be reflected from the antenna structure 32 due to a mismatch between the transmission line impedance and the antenna's input impedance. This reflected energy follows the same signal path as the incoming desired signal back to the receiver module 46.

The architecture 30 is also flexible to accommodate other wireless communications protocols. For example, a pair of switches 40 and 42 can be provided that are controlled by the DBP 56 to direct the receive and transmit signals through dedicated fixed RF devices 58, such as a global system for mobile communications (GSM) RF front-end module or a WiFi front-end module. In this embodiment, some select signal paths are implemented via conventional RF devices. FIG. 2 only shows one additional signal path, however, this concept can be expanded to any number of additional signal paths depending on use cases and services.

Delta-sigma modulators are a well known class of devices for implementing analog-to-digital conversion. The fundamental properties that are exploited are oversampling and error feedback (delta) that is accumulated (sigma) to convert the desired signal into a pulse modulated stream that can subsequently be filtered to read off the digital values, while effectively reducing the noise via shaping. The key limitation of known delta-sigma modulators is the quantization noise in the pulse conversion process. Delta-sigma converters require large oversampling ratios in order to produce a sufficient number of bit-stream pulses for a given input. In direct-conversion schemes, the sampling ratio is greater than four times the RF carrier frequency to simplify digital filtering. Thus, required multi-GHz sampling rates have limited the use of delta-sigma modulators in higher frequency applications. Another way to reduce noise has been to use higher order delta-sigma modulators. However, while first order canonical delta-sigma architectures are stable, higher orders can be unstable, especially given the tolerances at higher frequencies. For these reasons, state of the art higher order delta-sigma modulators have been limited to audio frequency ranges, i.e., time interleaved delta-sigma modulators, for use in audio applications or specialized interleaving at high frequencies.

The filter characteristics of a Delta-Sigma modulator may effectively be modified in order to compensate for Doppler shift. Doppler shift occurs when the transmitter of a signal is moving in relation to the receiver. The relative movement shifts the frequency of the signal, making it different at the receiver than at the transmitter. An exemplary system according to the present disclosure leverages the software-defined radio architecture to quickly estimate a shift in the carrier frequency and re-center the filter before the signal is disrupted or degraded. In normal operation, the notch of the modulator filter is centered about the expected carrier frequency of the received signal with the signal band information centered around the carrier frequency and not exceeding the bandwidth of the modulator filter. A Doppler shift would offset the carrier by an amount Δf causing potential degradation to signal content with an increase in noise at one side of the band. According to the method and system described herein, the transceiver in a wireless cellular communication system can adapt to changes in the RF carrier frequency and may maintain signal integrity, by shifting the filter notch by the same amount as the carrier frequency.

For the cellular application discussed herein that covers multiple assigned frequency bands, a transmitter with multi-mode and multi-band coverage is required. Also, many current applications mandate transmitters that rapidly switch between frequency bands during the operation of a single communication link, which imposes significant challenges to typical local oscillator (LO) based transmitter solutions. This is because the switching time of the LO-based transmitter is often determined by the LO channel switching time under the control of the loop bandwidth of the frequency synthesizer, around 1 MHz. Hence, the achievable channel switching time is around several microseconds, which unfortunately is too long for an agile radio. A fully digital PWM based multi-standard transmitter, known in the art, suffers from high distortion, and the channel switching time is still determined by the LO at the carrier frequency. A DDS can be used as the LO sourced to enhance the switching speed, however, this design consumes significant power and may not deliver a high frequency LO with low spurious components. Alternately, single sideband mixers can be used to generate a number of LOs with different center frequencies using a common phase-lock loop (PLL), whose channel switching times can be fast. However, this approach can only support a limited number of LO options and any additional channels to cover the wide range of the anticipated 4G bands would need extra mixtures. As discussed, sigma-delta modulators have been proposed in the art to serve as an RF transmitter to overcome these issues. However, in the basic architecture, a sigma-delta modulator cannot provide a very high dynamic range in a wideband of operations due to a moderate clock frequency. It is precisely because the clock frequency is constrained by current technology that this high frequency mode of operations cannot be supported.

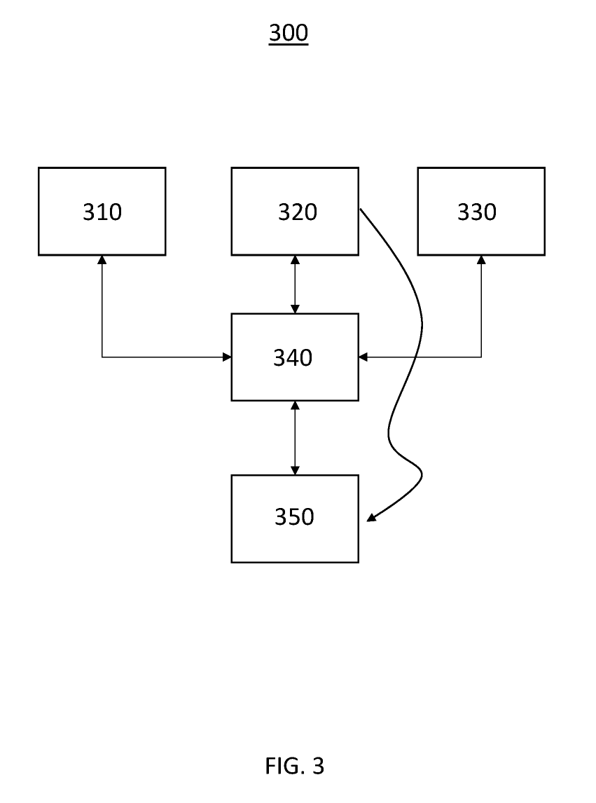

Turning now to FIG. 3, an exemplary system for implementing location aware software defined radio (SDR) optimization architecture is shown. The proposed approach is the complementary integration of four normally disparate sub-systems of a software defined radio: an SDR front end 350, a waveform database 310, a location sensor 320, diagnostic system 330, and a processor 340. The SDR front end 350 includes the tunable RF components. The location sensor 320 may be implemented using a GPS receiver and/or other chipsets, including the FlexRF front end, which can provide accurate or approximate location information. The waveform database 310 is the firmware/database containing the specific carrier agreements, waveform database and user profiles. The processor is used to implement a machine learning and processing algorithm that will act as the central processing engine for the system.

A software defined radio offers the possibility of flexible radio parameter settings, however, to efficiently set those parameters for a particular scenario or “use-case” requires situational awareness of the use-case, as well as any constraints. It is desirable to leverage otherwise disparate components of a traditional automotive telematics and sensing infrastructure, integrate them with the wide RF sensing capabilities of a true software defined radio and use an intelligent and learning computational engine that can guide the SDR's flexibility to efficiently generate the needed RF situational awareness. In addition, this feedback driven processing loop can subsequently direct the operation of the automotive SDR and dynamically adapt operational parameters to account for changing conditions.

The disclosed system is operative to improve the mobile user equipment (UE) initialization procedures and to enable the dynamic adaption of these radios to changing scenarios that is common for automotive applications. Currently, for mobile communication devices, both normal cell phones roaming outside of the home region or those installed in vehicles, the waveform and other RF physical layer parameters that are to be used for that device when the car is in a particular location in the world either has to be pre-programmed as part of carrier or service level agreements or needs to be orchestrated over a common channel interface by the local cellular network infrastructure. The UE radio is often “blind” regarding the true RF situation, and may be unduly constrained in the channels it can operate in, and consequently the data rates/services it can support. It would be desirable to facilitate a rapid, efficient method to determine the RF environment from the very specific user's location and point of reference and possible carrier and policy choices and to provide a highly optimized, and fine grained, way to control the ongoing operation of the radio, based on the dynamically changing channel conditions, automotive/UE prognostics and health condition, and any other user settable conditions.

The processor 340 implements a central optimization engine that takes as input data from 3 modules of the radio and directs the operation of the front-end of the software defined radio. The processor 340 may operate in two modes: 1) initialization, and 2) dynamic adaptation. The initialization mode is executed during power-up of the mobile device. The location sensor 320 is queried to determine the physical location of the device and the location data is coupled to the processor. Alternatively, in the instance where a location sensor is not available, the SDR front-end 350 may be configured as a location sensor to receive GPS information, or configured as a Wi-Fi receiver as well with appropriate back-end software, in order to determine location information. So, in practice, if a GPS or Wi-Fi chipset is not present in the automobile, the SDR front-end 350 may be able to perform the location sensing operation as part of the initialization operation. The location information is used to reduce the RF scanning requirements, since then the optimization engine can match the location to information in the carrier and user profile database rules for that specific geographic area stored in the waveform database 310. The location information is used to determine the actual bands that the phone can operate in, in accordance by the various service level agreement between the carrier, user, and service providers.

The optimization engine may be operative to initiate much more elaborate system optimization procedures. Given basic operational constraints set by user profiles, the SDR front-end can then scan the RF channels intelligently, based on quality and performance needs. For example, given the automotive condition (moving, stationary, prognostics or health condition) or user or application requirement (voice, video, mapping data request, diagnostics, etc.), an RF map can be constructed to prioritize channels to be used, coding rates, MIMO, carrier agg, etc. as well as other physical layer to application layer parameters to balance the service vs data needs. In addition, learning profiles can be constructed with time series history to further optimize the performance of the algorithm, and to tailor the profile as per the use case. Finally, this optimization engine can provide APIs to other applications hosted on the device custom tailor the operation of the phone as per the needs of the applications being directed by the user. A very fine grained and customizable control of the radio can be affected using this architecture than is currently possible with 4G or anticipated 5G cellular phone architectures.

In the dynamic adaptation mode, a feedback loop is periodically executed to essentially perform a subset of the initialization operation mentioned above. The RF front-end is used to periodically monitor and update the RF map as the automobile is in motion, or the applications or user preferences change over time. The goal is provide the best channel and link quality given the constraints and mobile user needs.

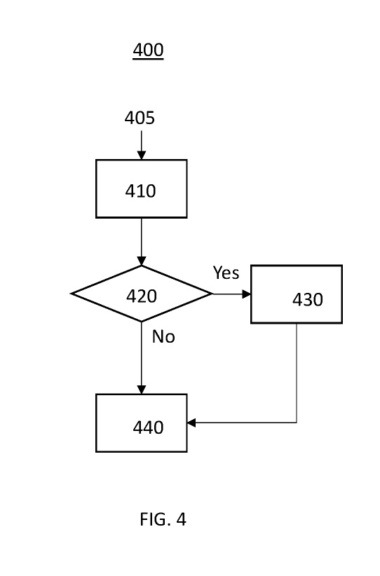

Turning now to FIG. 4, an exemplary method for implementing location aware software defined radio (SDR) optimization architecture 400 is shown. The method may be started in response to an initiation command 405 indicating that the system is operative to receive a signal. The initiation command 405 may be triggered by a system startup, a reconfiguration procedure, in response to a loss of signal, or a periodic system procedure to ensure optimal system performance.

In response to the initiation command 405, the method first retrieves location information 410. The location information 410 may be retrieved from a location sensor, a memory, or may be received in response to a request for the location information. Alternatively, the SDR may be configured in a manner to receive location information in the absence of a location sensor. The SDR may be configured to receive wireless network information, GPS data, or location information from a wireless communications provider.

Once the location information is retrieved, the method is then operative to compare the location information to a database to determine a desired waveform parameter 420. The waveform parameter is associated with a desired signal to receive associated with the location and/or a desired service provider. The method is then operative to retrieve the desired waveform parameter and optionally other information related to the location, such as that described previously. The method is then operative to retrieve the desired waveform parameter 430.

Once the waveform parameter is retrieved, the method applies the waveform parameter in order to configure the SDR to retrieve the desired signal 440. This configuration may include selecting a signal path and processor for the desired signal, selecting a bandpass filter, selecting an appropriate local oscillator frequency and setting additional filter parameters, such as bandwidth and center frequency. Once the SDR is appropriately configured for the desired signal, the method is operative to then decode the desired signal 450.

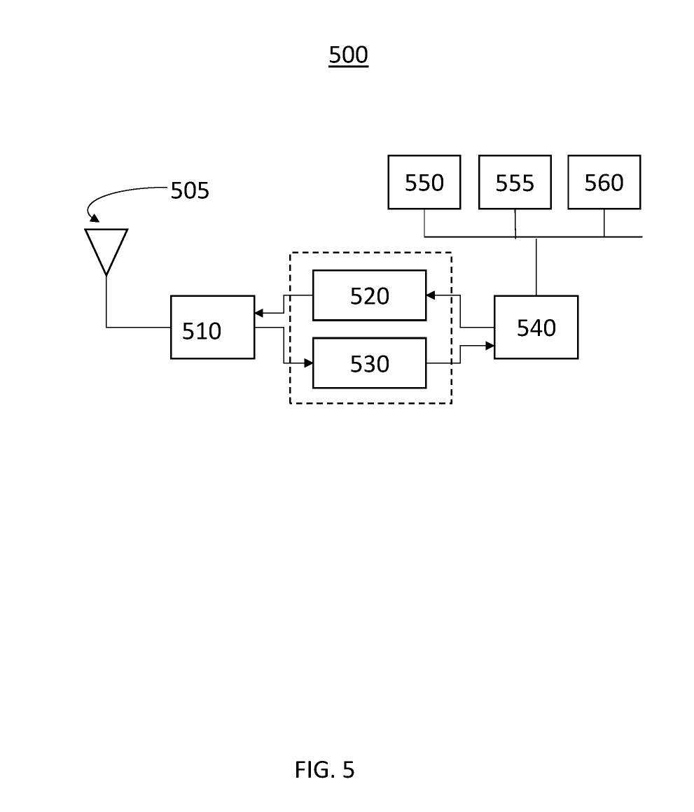

Turning now to FIG. 5, a transceiver for implementing location aware software defined radio (SDR) optimization architecture 500 is shown. The digital baseband and processing engine 540 is operative to request, transmit, and/or retrieve information different vehicle system via the vehicle telematics bus 550. This information may provide user inputs, automotive condition, such as moving, stationary, prognostic or health conditions, as well as application environment, such as voice, video, mapping data request, diagnostics, etc. Additionally, information is received from a waveform database 555 which includes information such as carrier profiles, user profiles, service agreement information, and associated waveform information. Additionally, the waveform database may include waveform parameters used to configure the SDR 530 and/or software definable transmitter 520. The digital baseband and processing engine 540 may further be operative to receive information from vehicle location sensors 560, such as GPS receiver, Wi-Fi or other location determination sensors.

At initiation of the system, or periodically as desired, a digital baseband and processing engine 540 is used to optimize and configure a SDR 530 and/or the software definable transmitter 520 in order to receive and/or transmit the desired signal. This configuration may include selecting a signal path and processor for the desired signal, selecting a bandpass filter, selecting an appropriate local oscillator frequency and setting additional filter parameters, such as bandwidth and center frequency.

The system is operative to receive a desired signal at an antenna 505 or another signal input. The desired signal is transmitted wirelessly to the apparatus and received at the antenna 505. The desired signal may then be coupled to a circulator 510, which is used in part to isolate the receive signal path of the transceiver from the transmit signal path of the transceiver. The digital baseband and processing engine 540 is then operative to continuously optimize and adapt the transmit and receive chains in order to optimally receive the desired signal. The digital baseband and processing engine 540 may further be operative to periodically monitor, request, or retrieve updated location data and compare this updated location data with the waveform database to ensure the most desired signal is being received. In the event of signal loss, the digital baseband and processing engine 540 may be operative to determine a new desirable signal in response to the location information and the information within the waveform database.

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

1. A method comprising:
determining a location;
determining a performance requirement;
determining a waveform parameter associated with the location in response to the location and the performance requirement;
configuring a software defined radio according to the waveform parameter; and
decoding a signal encoded according to the waveform parameter.

2. The method of claim 1 wherein the location is determined in response to a request to a location sensor.

3. The method of claim 1 wherein the location is determined in response to configuring the software defined radio to receive a wireless network signal and requesting the location from a wireless network.

4. The method of claim 3 wherein the wireless network is a cellular communications network.

5. The method of claim 3 wherein the wireless network is a wireless local area network.

6. The method of claim 1 wherein the waveform parameter is saved to a waveform database.

7. The method of claim 1 wherein the waveform parameter corresponds to a carrier associated with the location.

8. The method of claim 1 further comprising periodically determining a new location, determining a new waveform parameter associated with the new location and reconfiguring the software defined radio according to the new waveform parameter.

9. The method of claim 1 wherein determining the waveform parameter includes accessing a waveform database, retrieving the waveform parameter associated with the location.

10. The method of claim 9 wherein the waveform database includes at least one of a profile database, a service level agreement, an RF map, an application layer requirement, and a filter coefficient.

11. An apparatus comprising:
a location sensor for determining a location;
a memory for storing a waveform parameter;
a software defined radio for retrieving the waveform parameter in response to the location and a performance requirement, and for configuring the software defined radio in response to the waveform parameter, the software defined radio further operative to decode a signal according to the waveform parameter.

12. The apparatus of claim 11 wherein the location is determined in response to a request to the location sensor.

13. The apparatus of claim 11 wherein the location sensor is a global positioning system sensor.

14. The apparatus of claim 11 wherein the location sensor is a cellular communications network device

15. The apparatus of claim 11 wherein the location sensor is a wireless local area network transceiver.

16. The apparatus of claim 11 wherein the waveform parameter is saved to a waveform database.

7. The apparatus of claim 11 wherein the waveform parameter corresponds to a carrier associated with the location.

18. The apparatus of claim 11 wherein the software defined radio is further operative to periodically determine a new location, determine a new waveform parameter associated with the new location and reconfigure the software defined radio according to the new waveform parameter.

19. The apparatus of claim 11 wherein retrieving the waveform parameter includes accessing a waveform database, retrieving the waveform parameter associated with the location.

20. The apparatus of claim 19 wherein the waveform database includes at least one of a profile database, a service level agreement, an RF map, an application layer requirement, and a filter coefficient.
